(19) United States
(12) Patent Application Publication
(10) Pub. No.: US 2008/0153537 A1
(43) Pub. Date: Jun. 26, 2008

(54) DYNAMICALLY LEARNING A USER'S RESPONSE VIA USER-PREFERRED AUDIO SETTINGS IN RESPONSE TO DIFFERENT NOISE ENVIRONMENTS

(76) Inventors: Charbel Khawand, Miami, FL (US); Steven D. Bromley, Concord, MA (US)

Correspondence Address: DILLON & YUDELL, LLP, 8911 NORTH CAPITAL OF TEXAS HWY., SUITE 2110, AUSTIN, TX, 78759, US

(21) Appl. No.: 11/614,621

(22) Filed: Dec. 21, 2006

(51) Int. Cl. H04M 1/00

(52) U.S. Cl. 455/550.1

(57) ABSTRACT

A radio device 100 includes: a speaker 130, which outputs audio signals, a microphone 129 that detects and receives audible sounds within the surroundings of the radio device; an audio volume/characteristic adjusting mechanism 125, which selectively increases and decreases the volume level or other audio characteristics of the audio signal outputted from the radio device based on a user input; and means (150) for dynamically adjusting the audio volume and other audio characteristics of the audio signal based on a stored relational mapping, which links a user adjustment of the audio volume/characteristic to a specific audible sound previously detected within the environment by the microphone 129, such that future detection of the audible sound by the microphone 129 triggers the dynamically adjusting of the audio volume (320) and other audio characteristics.

### BACKGROUND OF THE INVENTION

1. Technical Field

The present invention relates generally to radio devices and in particular to audio settings of radio devices. Still more particularly, the present invention relates to a method and system for adjusting audio settings of radio devices.

2. Description of the Related Art

Manual volume adjustments for user-settable (or programmable) radio devices, such as cellular phones, are generally known in the art. With a vast majority of conventional radio devices, an affordance (e.g., a volume button or a scrollable wheel) is provided on the exterior of the radio device to enable the user to manually adjust a volume level on the radio device to improve the user's ability to hear audio output being played over a speaker of the device. In most conventional devices, the user is able to perform manual volume adjustments either prior to or during the user's listening experience.

Some more advanced radio devices, for example, cellular phones allow user-directed software setting of the volume level, whereby the volume setting is provided as a selectable option within a menu of software-enabled options. Thus, for example, the user may access a menu option on his phone's display and set the volume using software provided interface commands/options.

Each time a user turns the device's audio on, the user also try to make the necessary audio shaping adjustments (e.g. scaling different bands in response to a particular song in a particular noise environment) and/or scaling (e.g. turn up or lower their volume) the speaker energy during a voice call. The user continues to manually make these adjustments without any intelligent assistance from the radio. Usually the user's final audio settings corresponded to the user's better perception of audio.

The volume level at which the user feels comfortable listening to a particular audio output from the radio device is directly affected by the noise(s) (or other sounds) within the user's present environment (i.e., the immediate surroundings in which the user is listening to the audio output from the radio device). Regardless of the mechanism utilized by the user to adjust the volume on the user's radio device, radio device users have to constantly adjust their volume (or other audio parameters, e.g. frequency, band, tone/pitch) to account for a level and type of noise experienced in the user's environment. In addition to the adjustments required due to surrounding “environmental” noise, oftentimes the user may also adjust the volume (or other audio) setting on the radio device based on the type of audio being played on the speaker (e.g., audio playback, such as music, versus voice conversation). Also, the user may adjust the volume setting based on (1) the type of speaker being used (e.g., the built-in speaker in the device or an external wired headset speaker or a Bluetooth speaker) or (2) the setting of the speaker being used (i.e., normal internal speaker setting or speakerphone setting). The user's adjustments of the audio settings are reflective of the specific user's ear response to the different inputs, speaker devices, and environmental noises which affect the user's listening experience.

Since similar environments typically yield similar noises, the user typically performs similar audio adjustments each time the user is confronted with a similar environment in an effort to get clear (fully audible) audio output each time the audio is generated on the radio device. Thus, users frequently have to manually perform the necessary audio shaping and scaling to obtain the best (optimal) audio experience from the user's phone device. This repetitive act of going through different radio menus and volume control each time the user changes environment or each time an audio output is generated is inefficient. Notably, because the user typically does not know what the audio will sound like when the audio signal is first outputted, the initial set of audio output (at the beginning of a telephone conversation, for example) may be unclear and unintelligible, until the user is able to manually adjust the volume/audio settings on the device.

### SUMMARY OF THE INVENTION

Disclosed is a radio device that enables dynamic adjustment of volume and other audio characteristics based on detected noise from the environment around the radio device. The radio device comprises: a speaker, which outputs audio signals, a microphone that detects and receives audible sounds within the environment of the radio device; a mechanism for adjusting/shaping audio (including volume and other audio characteristics), which mechanism selectively increases and decreases the volume level and other characteristics of the audio signal outputted from the radio device based on a user input; and means for dynamically adjusting the audio volume and other audio characteristics of the audio signal to a first audio setting, based on a stored relational mapping, which links a previous user adjustment of the audio volume and/or other audio characteristics to the first audio setting in response to a specific audible sound detected by the microphone, such that future detection of the specific audible sound by the microphone triggers the dynamically adjusting of the audio volume and other audio characteristics to that first audio setting.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram representation of an example radio device, which is a cellular phone configured with the functional capabilities required for enabling dynamic volume and other adjustments for audio output, in accordance with one embodiment of the invention;

FIG. 2 is an example schematic diagram of an environment within which the radio device of FIG. 1 may be utilized, according to one embodiment;

FIG. 3 is a block diagram of internal functional sub-components of an environment-response audio shaping (ERAS) utility according to one exemplary embodiment of the present invention;

FIG. 4 depicts example ERAS tables/database, which stores parameters utilized to provide the response features of the ERAS utility, in accordance with one embodiment of the invention;

FIG. 5 is a flow chart illustrating the process of collecting user-response data to environmental conditions and updating the noise response database to shape future listening experience via the ERAS utility, in accordance with one embodiment of the invention; and

FIG. 6 is a flow chart illustrating the process by which the ERAS utility responds to detected environmental conditions to dynamically adjust the audio settings of a radio device to automatically shape the user's listening experience based on historical data, according to one embodiment of the invention.

### DETAILED DESCRIPTION OF AN ILLUSTRATIVE EMBODIMENT

The present invention provides a radio device and associated method and computer program product that enables dynamic adjustment of volume based on detected noise from the environment around the radio device. The radio device comprises: a speaker, which outputs audio signals, a microphone that detects and receives audible sounds within the surroundings of the radio device; an audio characteristic shaping/adjusting mechanism, which selectively increases and decreases the volume lever of the audio signal outputted from the radio device based on a user input; and means for dynamically adjusting the audio volume of the audio signal based on a stored a relational mapping, which links a previous user adjustment of the audio volume to a specific audible sound detected by the microphone, such that future detection of the audible sound by the microphone triggers the dynamically adjusting of the audio volume.

In the following detailed description of illustrative embodiments, specific illustrative embodiments by which the invention is practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims and equivalents thereof.

The figures described below are provided as examples within the illustrative embodiment(s), and are not to be construed as providing any architectural, structural or functional limitation on the present invention. The figures and descriptions accompanying them are to be given their broadest reading including any possible equivalents thereof.

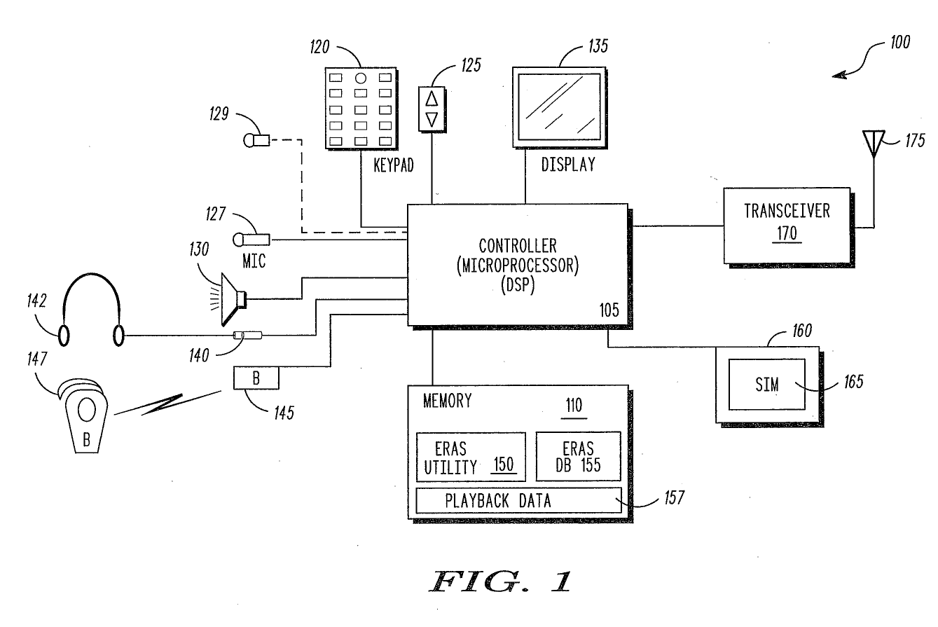

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

It is understood that the use of specific parameter names are for example only and not meant to imply any limitations on the invention. The invention may thus be implemented with different nomenclature/terminology utilized to describe the parameters herein, without limitation.

With reference now to the figures, FIG. 1 is a block diagram representation of an example radio device, configured with the functional capabilities required for enabling dynamic volume adjustment for audio output, in accordance with one embodiment of the invention. According to the illustrative embodiment, radio device 100 is a cellular/mobile phone. However, it is understood that the functions of the invention are applicable to other types of radio devices and that the illustration of radio device 100 and description thereof as a cellular phone is provided solely for illustration.

Radio device 100 comprises central controller 105 which is connected to memory 110 and which controls the communications operations of radio device 100 including generation, transmission, reception, and decoding of radio signals. Controller 105 may comprise a programmable microprocessor and/or a digital signal processor (DSP) that controls the overall function of radio device 100. For example, the programmable microprocessor and DSP perform control functions associated with the processing of the present invention as well as other control, data processing and signal processing that is required by radio device 100. In one embodiment, the microprocessor within controller 105 is a conventional multi-purpose microprocessor, such as an MCORE family processor, and the DSP is a 56600 Series DSP, each available from Motorola, Inc.

As illustrated, radio device 100 also comprises input devices, of which keypad 120, volume controller 125, and microphone 127 are illustrated connected to controller 105. Additionally, radio device 100 comprises output devices, including internal speaker 130 and optional display 135, also connected to controller 105. According to the illustrative embodiment, radio device 100 also comprises input/output (I/O) jack 140, which is utilized to plug in an external speaker (142), illustrated as a wire-connected headset. In an alternate implementation, and as illustrated by the figure, Bluetooth-enabled headset 147 is provided as an external speaker and communicates with radio device 100 via Bluetooth adapter 145.

These input and output devices are coupled to controller 105 and allow for user interfacing with radio device 100. For example, microphone 127 is provided for converting voice from the user into electrical signals, while internal speaker 130 provides audio signals (output) to the user. These functions may be further enabled by a voice coder/decoder (vocoder) circuit (not shown) that interconnects microphone 127 and speaker 130 to controller 105 and provide analog-to-digital and or digital-to-analog signal conversion. According to the invention, microphone 127 may also be utilized to detect and enable recording of environmental sounds (noise) around the radio device (and the user while audio output is being provided on internal (or other) speaker of radio device 100. In an alternate embodiment, a separate microphone (or multiple microphones), for example, environmental-response audio shaping (ERAS) mic 129, is provided to specifically detect background/environmental noise during operation of radio device 100. With this alternate embodiment, microphone 127 is utilized to detect voice communication from the user and all other sounds are filtered out. The detection of background/environmental sounds and applicability thereof to the invention is described in greater details below.

In addition to the above components, radio device 100 further includes transceiver 170 which is connected to antenna 175 at which digitized radio frequency (RF) signals are received. Transceiver 170, in combination with antenna 175, enable radio device 100 to transmit and receive wireless RF signals from and to radio device 100. Transceiver 170 includes an RF modulator/demodulator circuit (not shown) that transmits and receives the RF signals via antenna 175. When radio device 100 is a mobile phone, some of the received RF signals may be converted into audio which is outputted during an ongoing phone conversation. The audio output is initially generated at speaker 130 (or external speaker 142 or Bluetooth-enabled headset 147) at a preset volume level (i.e., user setting before dynamic adjustment enabled by the present invention) for the user to hear.

When radio device 100 is a mobile phone, radio device may be a GSM phone and include a Subscriber Identity Module (SIM) card adapter 160 in which external SIM card 165 may be inserted. SIM card 165 may be utilized as a storage device for storing environmental sounds/noise data for the particular user to whom the SIM card identifies. SIM card adapter 160 couples SIM card 165 to controller 105.

In addition to the above hardware components, several functions of radio device 100 and specific features of the invention are provided as software code, which is stored within memory 110 and executed by microprocessor within controller 105. The microprocessor executes various control software (not shown) to provide overall control for the radio device 100, playback data 157, such as music files that may be played to generate audio output, and more specific to the invention, software that enables dynamic audio/volume control based on detected environmental noise. The combination of software and/or firmware that collectively provides the functions of the invention is referred to herein as an environment-response audio shaping (ERAS) utility.

As provided by the invention and illustrated within memory 110, an ERAS utility 150, has associated therewith an ERAS database 155. The functionality of the ERAS utility 150 and the ERAS database 155 will be described in greater details below. However, when executed by microprocessor, key functions provided by the ERAS utility 150 include, but are not limited to: (1) receiving an input of environmental noise detected around the radio device; (2) filtering the environmental noise for specific parameters that uniquely identifies characteristics of the environmental noise; (3) detecting user adjustments to characteristics of the audio output; (4) linking the user adjustments to the specific parameters within a table of stored noise-response data; (5) dynamically implementing a similar response when a later audio output is generated for output within an environment having similar parameters as the specific parameters to provide a similar user listening experience without requiring manual user adjustments.

Those of ordinary skill in the art will appreciate that the hardware depicted in FIG. 1 may vary depending on implementation. Other internal hardware or peripheral devices may be used in addition to or in place of the hardware depicted in FIG. 1. Also, the processes of the present invention may be applied to a portable/handheld data processing system or similar device capable of generating audio output. Thus, the depicted example is not meant to imply architectural limitations with respect to the present invention.

The present invention assists the user in defaulting to the right audio settings by remembering (e.g. Smart averaging) in time what the user's audio adjustments were in response to different noise levels present at the radio device's microphone. The ERAS utility 150 remembers (stores) the noise levels at the user's microphone and the adjustments made by the user in response to those noise levels and the type of audio that is playing. This gives the user a much better audio experience overall. Although the term “noise level” is used extensively herein to refer to the noise characteristic of an environment, the background “noise” may be alternatively characterized as “a specific audible sound”, which includes instances wherein the background audio is, for example, narrow band.

Referring now to FIG. 2, there is illustrated an example general system environment within which features of the invention may advantageously be implemented. More specifically, FIG. 2 is an example schematic diagram of a series of adjacent sub-environments having distinguishable environmental noises and within which radio device 100 of FIG. 1 may be operated, according to one embodiment. Three different environments (i.e., areas in which different background sounds are detected by microphone 127/129 and are uniquely quantifiable/distinguishably identifiable by the ERAS utility 150) are illustrated, namely Environment 0 (En0) 210, En1 220, and En2 230. These environments may correspond to (a) location-based environments, such as in-vehicle environment, in-home environment, and in restaurant environment, respectively, or (b) activity-based environments, such as at a basketball game, on a train, and at a social gathering, respectively, at which different environmental noises are detected during operation of radio device 100. It is understood that any number of environments may be defined by the ERAS utility, depending primarily on the actual distinguishable environments in which the user of radio device 100 operates radio device 100 during generation and/or updating of ERAS database 155, as described below.

Radio device 100 is operated in each environment by the user and radio device 100 detects a particular, different background (environmental) noise, namely N0 212, N1 222, and N2 232, respectively, within each specific environment. The directional arrows indicate the movement of radio device 100 through the three example environments, which have an associated background noise (N0, N1, and N3) detected and/or recorded (by microphone 127/129) within the particular environment.

As these background noises are detected by the user, the user performs certain manual adjustments to the audio settings of radio device 100. For simplicity of describing the invention, the various audio adjustments will be described as volume adjustments. It is however understood that the invention tracks/monitors various other audio setting adjustments made by the user including, for example, the audio frequency, tone/pitch, and others. With FIG. 2, these adjustments are represented as Vol. Adj0 214, Vol. Adj1 224, and Vol. Adj2 234, each associated with the specific environment within which the adjustment is made. These manual volume adjustments are performed using volume controller 125, and the levels and/or final settings of these adjustments are recorded by ERAS utility 150 within ERAS database 155.

For purposes of the description, each noise is assumed to have specific noise parameters (or characteristics) that are individually discernable and quantifiable. ERAS utility 150 includes the software functions required for quantifying these noise parameters when the noise is detected during operation of radio device 100. For simplicity, the invention defines the collection of differentiating characteristics for sound/noise detected within a particular environment as a single “image” of the noise. That image is represented by specific sound/noise parameters (P0-PN, where N is any integer number representing the largest number of granular distinctions utilized to distinguish the identifying parameters for the various environmental sounds). These parameters are also utilized to determine when radio device 100 is later operated in a similar environment (from a sound/noise perspective). The parameters are defined and quantified by ERAS utility 150 in a manner which enables ERAS utility to deduce/obtain each parameter from a similar environmental sound/noise when the device is operated in a similar (or the same) environment, at a later time.

Notably, also illustrated by FIG. 2, each environment is assigned a particular ERAS-provided automatic audio (volume) adjustment or settings, namely ERAS0 216, ERAS1 226, and ERAS2 226. These volume adjustments represent the specific adjustment to (or setting of) the volume level performed by ERAS utility 150 when the device is later operated in the corresponding environment (assuming the presence of the same or similar environmental noise, N0, N1, and N2, respectively).

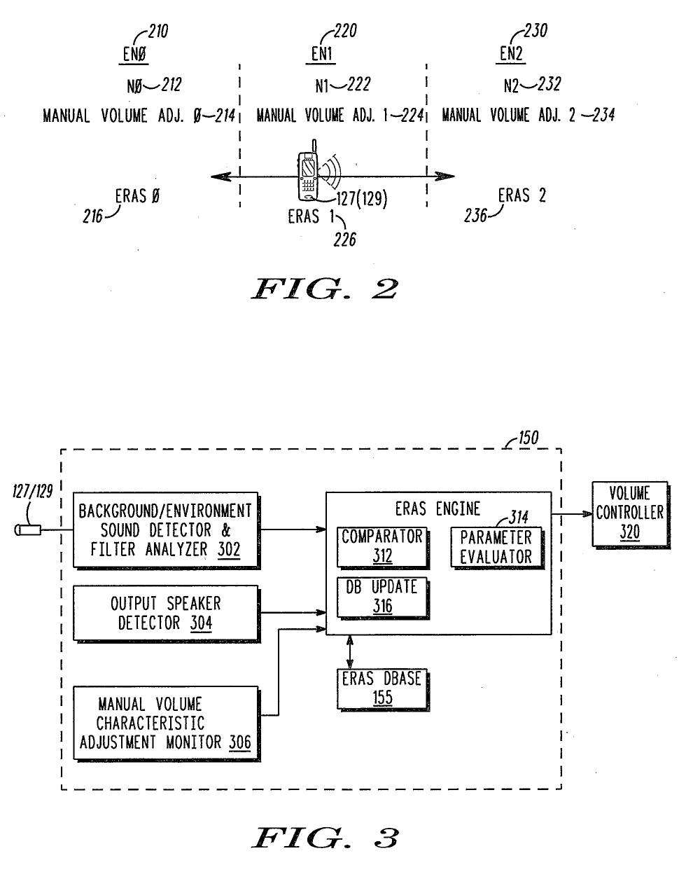

FIG. 3 is a block diagram of internal functional sub-components of ERAS utility 150, each presented as a function block, according to one exemplary embodiment of the present invention. As shown, ERAS utility 150 comprises sound detector/analyzer 302, which is coupled to and receives environmental sounds from microphone 127/129. ERAS utility 150 further comprises output speaker detector 304, which is utilized to identify the specific one of multiple possible speakers (130, 142, 147) through which audio from radio device 100 is outputted to the user, and the type of audio being generated (e.g., voice or music playback). Such identification may be done, for example, by the output speaker detector 304 finding an identification (at a known memory or register location) or receiving an identification (from another software function) of a output speaker and type of output that are enabled for use by the radio device 100. ERAS utility 150 also includes manual volume adjustment monitor 306, which detects manual adjustments by the user of radio device 100 within identified environments, while specific audio type (playback, voice or other) is being outputted from radio device 100. In one embodiment, manual volume adjustment monitor 306 detects the level of the adjustment (e.g., plus or minus M units, where M is a numeric value) from a default level. In another embodiment, volume adjustment monitor 306 detects the actual level at which the volume and/or other audio characteristics are set.

In addition to the above monitors and detectors, the ERAS utility 150 also comprises an ERAS engine 310, which includes several functional blocks for processing received data, including, but not limited to, comparator 312, database (DB) update 316, noise parameter evaluator 314, among others. Comparator 312 is utilized to determine whether the present environment or current audio type or current speaker (depending on implementation) is one that has an entry within ERAS database 155. This function is performed by comparing the parameter values, determined by noise parameter evaluator 314, of the sound image received from that environment. DB update 316 generates new entries within Database 155 and iteratively or periodically updates/refines the existing entries as later data is received (e.g., a detecting new user setting of the volume in the same environment). ERAS engine 310 provides an output to volume controller 320. Volume controller 320 enables software level control/adjustment of the volume level of the audio being outputted from the speaker of radio device 100.

Notably, in one embodiment, ERAS engine 310 provides an input mechanism whereby a user may activate or turn off the automatic audio adjusting functions provided by ERAS engine 310. A user may decide not to utilize the functions available and simply turn the engine off. The user may also activate/turn on the engine when the engine is turned off. In yet another embodiment, a single radio device may support/have multiple ERAS databases that may be generated for different users of the same phone. The current user of the phone would then identify himself by inputting some identifying code. Alternatively, the device may itself perform user identification by matching the audio characteristics of the user's voice to one of the one or more existing/pre-established voice IDs for each user who utilizes the device. In another embodiment, the user may also adjust or determine the rate of change at the output by entering/selecting a change rate parameter (i.e., how fast does the user want ERAS utility 140 to change the output when moving from one audio setting to another.

As indicated by the direction of the arrows, detector/filter/analyzer 302, output speaker detector 304 and manual volume adjustment monitor 306 each provide an output, which is inputted to ERAS engine 310. ERAS engine 310 then performs one of several primary processes using one or more of the various functions within ERAS engine to: (1) generate a new entry to ERAS database 115; (2) update an existing entry to ERAS database 115; (3) determine an appropriate volume control from an entry within ERAS database 115; (4) dynamically initiate the appropriate volume level change via volume controller 320.

While specifically shown to include software/firmware level functional components, it is contemplated that various functions of the invention may involve the use of either hardware or software synthesizers, filters, mixers, amplifiers, converters, and other sound analysis components. The specific description herein is thus solely intended to provide an illustration of one possible embodiment by which the features may be implemented, and are not intended to be limiting on the invention, which is to be given the broadest possible scope to cover any equivalent implementations.

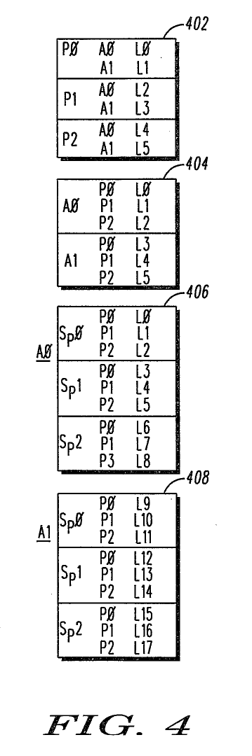

Turning now to FIG. 4, there is illustrated an exemplary representation of table entries within ERAS database 155 according to different embodiments of the invention. These entries correspond to the environments depicted by FIG. 3. ERAS database 115 stores parameters utilized to provide the audio response features of the ERAS utility. Three different embodiments are provided and depicted with first table 402, second table 404 and a combination of third table 406 and forth table 408.

In first table 402, each environment (EN0, EN1, EN2) is represented by a corresponding parameter (or set of parameters), which uniquely identifies that specific environment. Thus as shown EN0 210 maps to parameter0 (P0), EN1 210 maps to P1, and EN2 210 maps to P2. Within first table 402, two different audio outputs are supported, namely audio 0 (A0) and A1. As an example, A0 may refer to playback (or music) audio output from radio device 100, while A1 refers to voice audio output. Each different audio output within the specific environment is provided a specific dynamic volume response, indicated as levels (0-5). Thus, in EN0, represented by P0, detection of playback audio output (A0) through a speaker of radio device 100 triggers an automatic adjustment of the volume level to L0. Also, in EN2, represented by P2, detection of voice audio output (A1) through a speaker of radio device 100 triggers an automatic adjustment of the volume level to L5. ERAS utility 150 thus provides two possible responses within each environment, depending on whether radio device 100 is outputting playback or voice audio. First table 402 assumes ERAS utility 150 performs audio adjustments based primarily on an initial detection of the environment in which radio device 100 is currently operating. According to the described embodiment, each channel, voice or playback, is processed with its own audio pre-settings and then mixed to form one audio output to the speaker or audio accessory.

Second table 404 illustrates the tracking of the audio response by ERAS utility 150 based on the current type of audio output (A0 or A1). This alternative embodiment provides the same information as the first table 402, but organized differently. ERAS utility 150 first identifies the type of audio output. Then, ERAS utility 150, determines which of the environments (respectively represented with parameters P0, P1, P3) the radio device is in, and responds with the appropriate adjustment of volume (and/or other audio characteristics) for that environment (i.e., the environmental noise detected) and type of audio.

Third table 406 and fourth table 408 collectively represent a next level of complexity to the determination provided by ERAS utility 150, wherein the type of speaker through which the audio output is being played is taken into account. Third table 406 provides data for playback/music output (A0), while forth table 408 provides data for voice output (A1). SP0, SP1, and SP2 may be assumed to respectively represent internal speaker 130, external speaker 142, and Bluetooth headset 147. Those of skill in the art of audio output generation are aware that each output device (speaker) provides a different sound quality and clarity, among other distinctions, that affect the user' listening experience. Each device therefore is provided an individual level of volume (audio) control by ERAS utility 150. As an example, when playing music (A0) though internal speaker 130 (Sp0), within E0 (which is represented by P0 within the table), ERAS utility 150 provides volume adjustment of L0 (as shown at third table 406 corresponding to playback/music audio (A0)).

Notably, in each of the above tables, the volume adjustment level may be one that is determined by an earlier detection of a manual user setting, which setting is then stored within the table as the level for that environment when playing that specific audio output (on the specific speaker). Additional parameters/components affecting the audio output may be monitored and included within the tables, adding even more levels of complexity to the tables. By the time an entry is created within ERAS database 155, the environment data is known and ERAS utility may later utilize the entry to determine an appropriate adjustment to the volume (or other audio characteristics) when the user later operates radio device 100 within an environment similar to the entered environment. ERAS utility 150 associates a specific audio shaping profile (e.g., volume setting, tone setting, etc.) as an automatic setting, triggered in response to an environment that the user is in that is similar to a previously known and quantified environment. Notably, ERAS utility 150 may continually update the settings within the tables as new environmental factors are detected and as the user continues to tweak/adjust the settings dynamically applied by ERAS utility 150 during audio output.

In one embodiment, ERAS utility 150 also provides audio adjustments based on a language parameter. The user of the device may set certain preferences regarding the type of language being spoken by the user, by an incoming caller, during playback, or generally in the environment. With this language parameter defined, if the language heard or spoken changes (even within the same noise environment), then ERAS utility 150 automatically adjusts the user settings for that new language, based on pre-defined or known voice/audio differences between the languages. In one implementation, one audio setting is utilized within the table for one language and that setting may be automatically adjusted by the ERAS utility 150 for another language.

In yet another embodiment, ERAS utility 150 also provides a mechanism for determining the environment based on a known or detected geographic/physical location. In one implementation a GPS receiver is provided within the device and provides the device's GPS location. ERAS utility 150 then takes the physical location of the radio device into account before making any adjustments to the audio setting. The GPS location may be utilized in modes where the radio does not have to wake periodically to take a snapshot of microphone samples to estimate surrounding noise.

Implementation of the invention saves the users from having to manually adjust their audio settings in response to the type of audio playing and the type of noise present around them. The algorithm begins when the user opens up an audio path to any accessory present on their radios to play a particular audio stream. ERAS utility 150 begins by profiling the noise levels through the radio microphone (or microphones) and ties them to the type of audio that is playing. In one embodiment, a dedicated microphone (or multiple microphones, placed at different positions) can be used to pick up the surrounding signals. In the embodiment in which multiple microphones are provided, an average noise value is taken by monitoring the noise levels at each microphone and then averaging out the noise levels. ERAS utility 150 will then remember what type of audio adjustments are made by the user for the average noise level as well as the type of noise detected.

The next time the user tries to play the same audio type, ERAS utility 150 adjusts the settings to the settings previously recorded for the environment. If the user modifies the settings again during similar noise levels, then ERAS utility 150 updates the recorded audio settings. If however, the noise levels (of the present environment) were not found in the history tables, a new environment entry is added for that new noise level, and those settings are recorded under that new noise level entry. Additionally, if an accessory is not found, a new ERAS accessory entry can be instantiated on the fly for the current environment. This feature makes ERAS updating a dynamic process that allows the ERAS database to grow without having to update the radio's software. In time, the algorithm examines the different entries in all the tables and tries to compress the information into a DSP filter, which captures the user's ear response in the presence of noise. Once this information is compressed into the DSP filter, the filter or filters are used to provide the user with his preferred audio settings given the different types of Noise levels and the type of audio that is used.

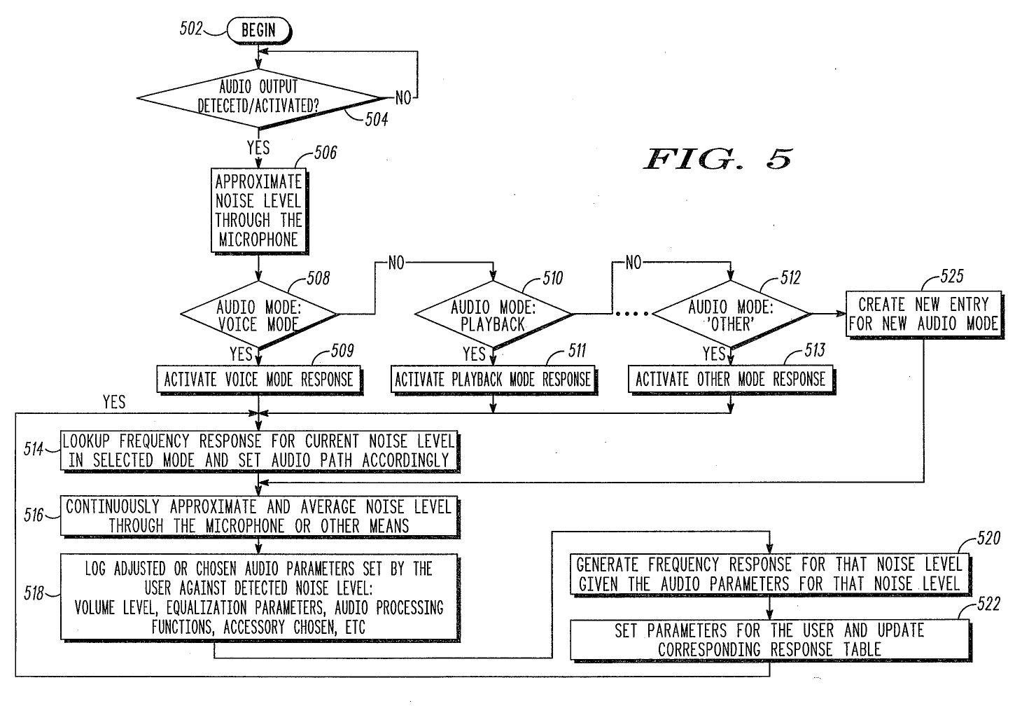

FIG. 5 is a flow chart illustrating the processes of collecting user settings made in response to detected environmental noise, and iteratively updating the environment response database via ERAS utility 150, in accordance with one embodiment of the invention. The process begins at block 502 and proceeds to decision block 504 at which ERAS utility 150 detects that an audio output is activated on radio device 100. Notably, ERAS utility 150 requires output of audio from radio device 100 to proceed with the processing. If no audio output is activated, the process idles, returning to the input of block 504 since each of the three embodiments described herein requires an output of audio to trigger ERAS utility 150. When an audio output is activated, ERAS utility 150 approximates the noise level received from the environment through the microphone (127/129), as shown at block 506. In some embodiments, this may be performed shortly before the desired audio is generated, to make a more reliable determination of the present environment. In some embodiments, the audio may be delayed by a small amount, such as 100 msec, to perform this function. In yet another embodiment, ERAS utility 150 may include a filter that is utilized to filter (i.e., remove out) the actual audio output from the received audio at the microphone (127/129). In this embodiment, the background/environmental noise is detected and analyzed during actual audio output.

Returning to FIG. 5, ERAS utility 150 then determines at decision block 508 whether the audio mode (i.e., the type of audio being outputted) is voice mode. If the audio mode is not voice mode, ERAS utility checks at decision block 510 whether the audio mode is playback (i.e., music audio) mode. Assuming the audio mode is not voice mode nor playback mode, then ERAS utility 150 continues to decipher the audio to determine which “other” mode is being outputted, as shown at block 512.

Assuming no known mode is determined or found within the database, a new ERAS entry is instantiated on the fly for that undeterminable mode, as shown at block 525. This feature makes ERAS a dynamic process that allows the ERAS database to grow without having to update the radio's software. Once the audio mode is determined, ERAS utility 150 activates the appropriate audio mode processing, as provided at blocks 509, 511 and 513. ERAS utility 150 then completes a series of processes to record/update the parameters associated with the particular audio mode (within the specific environment). Since the processes are similar for each audio mode, a general description of the process is provided. Where appropriate, processes related to specific audio modes are identified. It should be noted that the above description is not intended to limit the use of multiple audio channels and then mix these multiple channels together. In this situation, ERAS processing first occurs at every channel type, and then the outputs are mixed to form one single output.

With the audio mode identified, ERAS utility 150 looks up the frequency response (in that audio mode) for the current noise level detected within the environment, as shown at block 514 and ERAS utility 150 makes the audio path settings based on the frequency response. ERAS utility 150 continuously or periodically approximates the average noise level received through the microphone as shown at block 516. The actual rate of monitoring the environmental noise can be different for the different modes (voice, playback, etc.). Also, the rate of monitoring is adjusted and/or reduced, when ERAS utility 140 determines that the current rate of monitoring (i.e., collecting data about) the surrounding environment provides no measurable benefit in the final audio adjustments.

As shown at block 518, ERAS utility 150 adjusts the log (table entry) and/or selected audio parameters set by the user in response to the detected noise level. Among these user-settable parameters are volume level, equalization parameters, audio processing functions, and chosen accessory, among others. ERAS utility 150 then generates the frequency response for the specific noise level given the audio parameters for that noise level, as shown at block 520. The ERAS utility 150 sets the frequency response audio level for the user and updates the appropriate audio mode response table (i.e., the voice mode response table, playback response table or other response table), as shown at block 522.

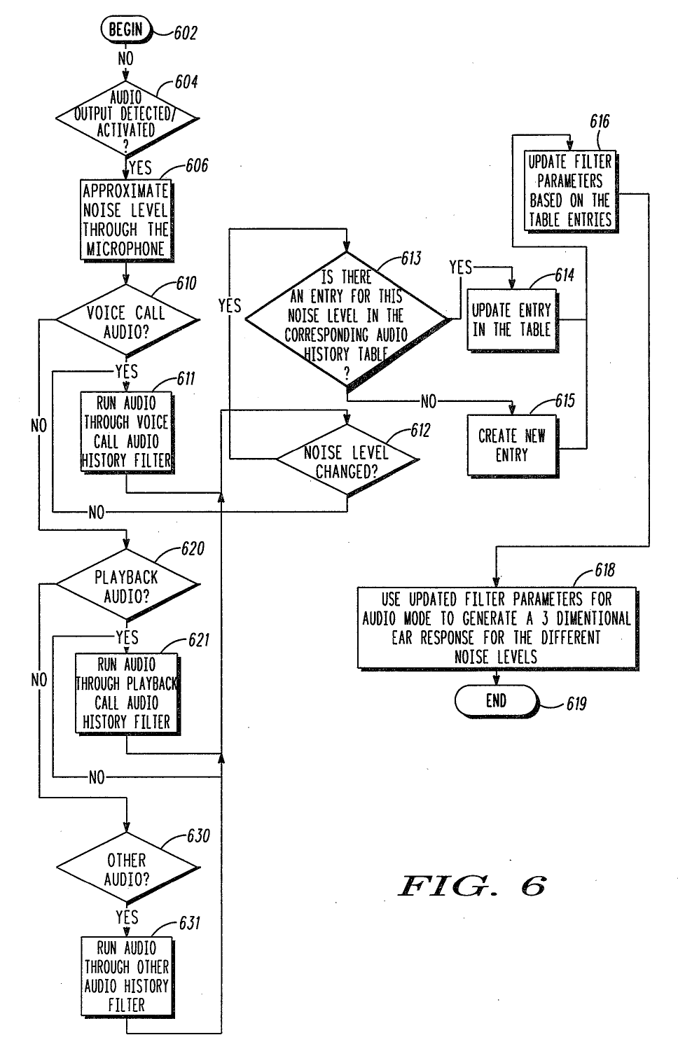

Referring now to FIG. 6, which is a flow chart illustrating the process by which ERAS utility 150 responds to detected environmental conditions to dynamically adjust the audio settings of radio device to automatically shape the user's listening experience based on historical data, according to one embodiment of the invention. The process begins at block 602 and proceeds to block 604 at which ERAS utility 150 detects activation of an audio output from radio device 100. Once audio output is detected, ERAS utility 150 approximates the noise level detected through the microphone as shown at block 606. In some embodiments, this may be performed shortly before the desired audio is generated, to make a more reliable determination of the present environment. In some embodiments, the audio may be delayed by a small amount, such as 100 msec, to perform this function. In yet another embodiment, ERAS utility 150 may include a filter that is utilized to filter (i.e., remove out) the actual audio output from the received audio at the microphone (127/129). In this embodiment, the background/environmental noise is detected and analyzed during actual audio output.

ERAS utility 150 determines at block 610 whether the audio being outputted is a voice call audio. If the audio is not a voice call audio, ERAS utility 150 determines at block 620 if the audio is a playback audio (e.g., music). When not a playback audio, ERAS utility 150 again determines at block 630 what other type of audio is being outputted. Once the audio mode is determined, ERAS utility 150 completes a series of processes to determine which stored parameters associated with the particular audio mode within the specific environment are present. As with the description of FIG. 5 above, since the processes are similar for each audio mode, only a general description of the process is provided. Where appropriate, specific audio mode(s) are identified within the description.

ERAS utility 150 runs the detected audio through an appropriate audio history filter, from among “voice call audio history filter, “playback audio” history filter and “other audio” history filter, as shown at block 611. As a part of this process, ERAS utility 150 assigns parameters corresponding to the characteristics of the detected audio, compares the assigned parameters of the detected audio with stored parameters corresponding to similar characteristics of the previously detected and evaluated environments, and then determines if the assigned parameters of the detected audio are substantially similar to the stored parameters of any one of the previous environments. ERAS utility 150 determines that a newly detected audio is substantially similar to that of a previously detected environment using pre-set criteria that provides assurance that the present (detected) environment is the same or sufficiently similar to the previously measured environment. When this determination is made, the parameters are said to “match” each other, thus indicating a similar (or substantially similar) environment. In one embodiment, the term “substantially similar” (and/or “match”) applies to parameters that would be generated from an environment with similar audio characteristics as the previously detected and evaluated environment, based on the overall effect of the audio characteristics on the listening experience of a user of the radio device. Once the parameters of the detected audio are determined, they are stored within the ERAS database along with user response data, where such data is received/detected.

Returning to FIG. 7, ERAS utility 150 determines at block 612 whether the noise level (environment type) has changed (for the particular audio type). If the noise level has changed, ERAS utility 150 then determines at block 613 whether there is an entry for the specific noise level within the particular audio history table.” (voice-call audio history table, or playback audio history table or other audio history table). If there is already an entry for this noise level within the voice call audio history table, ERAS utility 150 updates the audio settings entry within the table, as shown at block 614. If there is not an entry within the table, ERAS utility creates a new entry, as shown at block 615, using the settings. The updates can be performed periodically.

Then, ERAS utility 150 updates the filter parameters based on the updated table entries, as shown at block 616. Following, ERAS utility 150 determines which mode of audio output radio device 100 is currently playing and at block 618, ERAS utility utilizes update filter parameters for the particular mode to generate a three dimensional ear response for the different noise levels. The process then ends at block 619.

This invention enhances the audio experience of users and can replace the manual operations that users perform in response to different noise environments. The invention is applicable to a radio device because users repeatedly adjust their audio while using their radios to play different types of audio.

As a final matter, it is important that while an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A radio device comprising:
a speaker, which provides audio outputs from the radio device;
one or more microphones that detect and receive audible sounds within an environment surrounding the radio device;
an audio volume adjusting mechanism, which selectively increases and decreases characteristics of the audio output, including a volume level of the audio output from the radio device based on a manual user input;
means for dynamically adjusting the audio characteristics of the audio output based on a stored relational mapping, which links a previous user adjustment of the audio characteristics to a specific audible sound detected by the one or more microphones, such that future detection of the audible sound by the one or more microphones triggers the dynamically adjusting of the audio characteristics.

2. The radio device of claim 1, wherein said means for dynamically adjusting further comprises:
a processor coupled to a memory; and
an environment-response audio shaping (ERAS) utility stored within the memory, and which executes on the processor to provide the functions of:
when a user adjustment of an audio setting of the radio device is detected, recording a current environmental sound being received at the microphone;
storing parameters identifying the current environmental sound along with a specific level to which the user adjusts the audio setting;
when a next environmental sound is received at the microphone, comparing new parameters of the next environmental sound with the stored parameters of the previously-detected current environmental sound; and
if the new parameters are substantially similar to the stored parameters, indicating a similar environment, activating the dynamic adjustment of the audio setting to the level associated with the stored parameters.

3. The radio device of claim 2, wherein said means for dynamically adjusting further comprises:
means for determining which speaker among multiple possible speakers to which the audio output may be sent is currently providing the audio output; and
means for storing speaker parameters corresponding to the speaker which is currently providing the audio output along with the stored parameters;
wherein an adjustment to the audio level is directly linked to the specific speaker that is currently being utilized to output the audio, such that a future adjustment is dynamically triggered when the parameters of the current speaker matches the stored speaker parameters associated with the specific environment within an ERAS database.

4. The radio device of claim 2, further comprising a receiver, which receives signals that are converted into the audio output for the radio device.

5. The radio device of claim 2, further comprising:
means for identifying a specific type of audio that is currently being outputted through the speaker;
means for associating audio type parameters with the stored environment parameters; and
wherein an adjustment to the audio level is directly linked to the specific type of audio that is currently being outputted, such that a future adjustment is dynamically triggered when the audio parameters of the currently playing audio matches the stored audio parameters associated with the specific environment within the ERAS database.

6. The radio device of claim 2, further comprising:
a global position satellite (GPS) receiver which provides a current GPS location of the radio device; and
means for associating the GPS location with specific environment parameters, wherein said adjusting of the audio characteristic occurs in response to the GPS receiver determining that the radio device is located in a first GPS location that is associated with a stored set of environment parameter, which trigger a corresponding adjustment of the audio characteristics.

7. The radio device of claim 2, further comprising:
means for evaluating a maximum rate of monitoring a surrounding environment that triggers a measurable adjustment in the audio characteristics above a pre-set minimum acceptable adjustment;
when the measurable adjustment falls below the pre-set minimum acceptable adjustment, means for automatically reducing the maximum rate of monitoring to a lower rate; and
means for dynamically adjusting the maximum rate of monitoring the surrounding environment based on a current mode of audio output being played on the radio device.

8. The radio device of claim 2, wherein said one or more microphones is a plurality of microphones, said device further comprising:
means for receiving an input from each of the plurality of microphones;
means for averaging the input received from said plurality of microphones to yield and average input that is utilized to complete the dynamically adjusting;
means for receiving outputs of multiple audio channels; and
means for mixing the outputs from the various multiple audio channels to form a single output.

9. The radio device of claim 2, further comprising:
means for checking existing databases for said accessory and said mode; and
when one or more of said accessory and said mode is not found within the databases, means for automatically adding within the database the one or more accessory and mode that is not found.

10. The radio device of claim 2, further comprising:
means for defining a language being spoken and outputted in the surrounding environment as an environmental parameter; and
means for accounting for the language being spoken in determining the type of adjustment to the audio characteristics, wherein a next language causes the ERAS utility to automatically adjust the audio settings to that corresponding to the language being spoken and outputted.

11. The radio device of claim 2, wherein said means for dynamically adjusting further comprises:
an audio filter associated with the ERAS utility and which is utilized to filter actual audio output from an overall audio received at the microphone;
wherein said ERAS utility further comprises:
when an initial transmission of the audio output is to begin:
means for delaying an initial transmission of the audio output during start-up of the audio output; and
means for detecting environmental noise around the radio device while the initial transmission is delayed; and
when the audio output is being transmitted, means for triggering the audio filter to filter out the actual audio output from the overall audio to provide a detected environmental noise.

12. The radio device of claim 1, further comprising:
a manual volume adjustment monitor that detects during the user adjustment one of (a) a level of the user adjustment to the audio setting from a default level and (b) an actual level to which the audio setting is set by the user adjustment;
wherein the means for dynamically adjusting adjusts the audio setting to a respective one of (a) the level of the user adjustment from the default level and (b) the actual level to which the audio setting is set by the user adjustment.

13. The radio device of claim 2, further comprising:
means for selectively activating the ERAS utility within the radio device; and
means for selectively turning off the ERAS utility within the radio device.

14. The radio device of claim 2, further comprising:
means for generating multiple ERAS databases assigned to multiple different users of the radio device;
means for activating use of a particular ERAS database corresponding to that current user; and
means for providing adjustments to the audio output based on the particular ERAS database currently activated.

15. The radio device of claim 1, wherein the device is a mobile cellular phone and comprises a wireless transceiver that enables wireless communication to and from the radio device and a secondary device.

16. A method comprising:
detecting audio characteristics within an distinguishable environment surrounding a radio device during presentation of an audio output from the radio device;
determining identifying characteristics about the distinguishable environment from the audio characteristics;
monitoring a user response during the detection of the audio characteristics to affect a change in the audio output to a definable level;
assigning one or more parameters to the identifying characteristics;
linking the user response to the one or more parameters;
storing the user response and the one or more parameters as an entry in a database;
continually updating the entry each time a new user response is detected for an audio characteristics of an environment that generates a similar set of one or more parameters; and
when a next audio output is presented from the radio device within a similar environment that has similar identifying characteristics as the distinguishable environment, dynamically adjusting the audio output to the definable level.

17. The method of claim 16, further comprising:
filtering out the audio output from environmental noise detected along with the audio output; and
analyzing the environmental noise to identify the audio characteristics and to assign the one or more parameters.

18. The method of claim 16, wherein the audio characteristics includes a noise level and the change in the audio output includes a change in the volume level, said monitoring step comprising determining a final volume level to which the user adjusts a volume of the audio output.

19. The method of claim 16, further comprising:
determining a type of audio output being presented by the radio device from among multiple possible audio outputs including voice output and playback output; and
further linking the type of audio output with the user response and the one or more parameters, wherein the dynamically adjusting the audio output to the definable level is provided for a similar type audio output.

20. The method of claim 16, further comprising:
determining a type of output device utilized to present the audio output from among multiple distinguishable output devices; and
further linking the type of output device with the type of audio output and the user response and the one or more parameters, wherein the dynamically adjusting the audio output to the definable level is provided for a similar type audio output on a similar type output device in a similar environment.

21. A computer program product comprising:
a computer readable medium; and
program code on the computer readable medium that when executed by a processing component within a radio device, provides the functions of:
detecting audio characteristics within an distinguishable environment surrounding a radio device during presentation of an audio output from the radio device;
determining identifying characteristics about the distinguishable environment from the audio characteristics;
monitoring a user response during detection of the audio characteristics, which response affects a change in the audio output to a definable level;
assigning one or more parameters to the identifying characteristics;
linking the user response to the one or more parameters;
storing the user response and the one or more parameters as an entry in a database;
continually updating the entry each time a new user response is detected for an audio characteristics of an environment that generates a similar set of one or more parameters; and
when a next audio output is presented from the radio device within a similar environment that has similar identifying characteristics as the distinguishable environment, dynamically adjusting the audio output to the definable level.

22. The computer program product of claim 21, wherein the audio characteristics includes a noise level and the change in the audio output includes a change in the volume level, said monitoring step comprising determining a final volume level to which the user adjusts a volume of the audio output.

23. The computer program product of claim 21, further comprising:
filtering out the audio output from environmental noise detected along with the audio output; and
analyzing the environmental noise to identify the audio characteristics and assign the one or more parameters.

24. The computer program product of claim 21, further comprising:
determining a type of audio output is being presented by the radio device from among multiple possible audio outputs including voice output and playback output; and
further linking the type of audio output with the user response and the one or more parameters, wherein the dynamically adjusting the audio output to the definable level is provided for a similar type audio output.

25. The computer program product of claim 24, further comprising:
determining a type of output device is utilized to present the audio output from among multiple distinguishable output devices; and
further linking the type of output device with the type of audio output and the user response and the one or more parameters, wherein the dynamically adjusting the audio output to the definable level is provided for a similar type audio output on a similar type output device in a similar environment.

26. The computer program product of claim 21, further comprising:
determining a type of output device is utilized to present the audio output from among multiple distinguishable output devices; and
further linking the type of output device with the user response and the one or more parameters, wherein the dynamically adjusting the audio output to the definable level is provided only for a similar type output device.
